(19) United States
(12) Patent Application Publication
(10) Pub. No.: US 2026/0180787 A1
(43) Pub. Date: Jun. 25, 2026

(54) Methods for Improving Sharing a Digital Key, Apparatus, Vehicle and Computer Program

(71) Applicant: Bayerische Motoren Werke Aktiengesellschaft, Muenchen (DE)

(72) Inventors: Liang CHEN, Muenchen (DE); Thorsten KNOTT, Tuntenhausen (DE)

(21) Appl. No.: 19/127,437

(22) PCT Filed: Dec. 6, 2022
(86) PCT No.: PCT/EP2022/084683

§ 371 Date: May 6, 2025

(51) Int. Cl. H04L 9/08; H04L 9/40

(52) U.S. Cl. CPC H04L 9/0825; H04L 63/08; H04L 63/083

(57) ABSTRACT

Embodiments relate to a method for sharing a digital key. The method generates invitation data indicative of key creation data and obtains sharing data indicative of a desired share of the key creation data. Further, the method generates shared data indicative of the invitation data based on the sharing data and displays the shared data.

### BACKGROUND AND SUMMARY

The present disclosure relates to the field of digital identity authorization. Embodiments relate to methods for improving sharing digital key, an apparatus, vehicle and computer program.

The Digital Car Key solution defined in the Car Connectivity Consortium's (CCC) standard release 3, Version 1.0.11 [1] standardizes an access system consisting of:
a) smartphone and software that
   i) carry a digital key embedded in secure storage on the smartphone;
   ii) offer interfaces from the secure storage to the smartphone operating system; and
   iii) offer interfaces from the smartphone operating system to other applications running on the smartphone (e.g., a vehicle original equipment manufacturer app);
b) a vehicle, allowing carriers of a digital key to operate certain vehicle functionalities; and
c) backend systems, interconnecting smart devices and vehicles allowing to share and manage digital keys and offer additional services.

Digital keys for a particular vehicle can only be shared by the owner key of the particular vehicle. The Owner Public Key is known to the vehicle through the owner pairing process. Key sharing is a multi-step process, in which the owner (e.g., using user equipment of the owner, also referred to as owner device) first configures the parameters of the digital key to be created (“key creation request”) and passes it them to the “friend” (e.g., user equipment of a friend, who should be allowed to use the vehicle, also referred to as friend device). Sharing the digital key may be as follows:
1. The user in possession of the owner device, initiates the sharing process on the owner device;
2. A “mailbox” containing the key creation data is created & encrypted on a relay server by the owner device;
3. An “invitation”, which consists of a link to the mailbox (2.) and an encryption token is created on the owner device;
4. The invitation is sent to the friend device using a messaging application, where the messaging application is chosen by the user initiating the sharing process;
5. The invitation is received on the sharees friend device;
6. The sharee “accepts” the invitation to start the process of installing the digital key on their friend device; and
7. Further steps are required in the sharing process, such like endpoint certificate export, key sharing attestation are performed.

However, the use of messaging application may be unsecure (man-in-the-middle attack, identity spoofing). Thus, there may be a need to improve an exchange of the invitation.

It is therefore a finding that sharing a digital key by displaying shared data indicative of invitation data. The invitation data is indicative of key creation data. By displaying the shared data multiple user equipment in close physical proximity can exchange or access the invitation data. Messaging applications can be tedious and potentially insecure and thus by displaying the shared data sharing of the digital key can be improved. The owner device can display the shared data, such that the friend device can scan the shared data. In this way, the security for sharing the digital key can be increased, for example.

Examples provide a method for sharing a digital key comprising generating invitation data indicative of key creation data. Further, the method comprises obtaining sharing data indicative of a desired share of the key creation data. The method further comprises generating shared data indicative of the invitation data based on the sharing data and displaying the shared data. By obtaining the sharing data a desired step to share the invitation data can be determined. Thus, shared data can be generated based on the sharing data. By displaying the shared data for the user, e.g., a use of the friend device, can receive information indicative of the invitation data. In this way, the owner device can provide the friend device the invitation data in an improved way.

In an example, the method may further comprise generating the key creation data and transmitting, to a server, the key creation data. Further, the shared data may be indicative of an address of the server, e.g., an URL-address, and URL-link. By transmitting the invitation data to the server, it can be ensured that the invitation data is stored in a safe place, e.g., a backend of vehicle original equipment manufacturer. In this way, the friend device can receive needed information to access the invitation data from a reliable source.

In an example, the generated shared data is a QR code. In this way, the reading of the shared data by the friend device can be facilitated.

In an example, the method may further comprise prohibiting screenshot during displaying the shared data. In this way, a security of the shared data can be increased.

In an example, the method may further comprise transmitting, to a vehicle, information about a usage of the shared data. In this way, the vehicle can receive information to decide whether to entrust the digital key shared using the shared data or not.

In an example, the sharing data may be obtained by receiving from user equipment (friend device) the desired share, receiving from an input of the user of owner user equipment (owner device) the desired share and/or by determining the position of the user equipment. In this way, displaying the shared data can be initiated when needed.

Examples provide a method comprising reading shared data displayed on owner user equipment to generate a friend digital key. In this way, the friend device can receive the shared data indicative of the invitation data in an improved way.

In an example, the method may further comprise transmitting, to the owner user equipment, sharing data indicative of a desired share of key creation data. In this way, the friend device can transmit information about a desired share to the owner user equipment.

Examples relate to an apparatus, comprising interface circuitry configured to, with owner user equipment or friend user equipment and processing circuitry, to perform a method as described above. Examples relate to a vehicle, comprising an apparatus as described above.

Examples further relate to a computer program having a program code for performing the method described above, when the computer program is executed on a computer, a processor, or a programmable hardware component.

Some examples of apparatuses, methods and/or computer programs will be described in the following by way of example only, and with reference to the accompanying figures.

### BRIEF DESCRIPTION OF THE DRAWINGS

FIG. 1 shows an example of a method for sharing a digital key;

FIG. 2 shows another example of a method for sharing a digital key; and

FIG. 3 shows a block diagram of an example of an apparatus for a vehicle.

### DETAILED DESCRIPTION OF THE DRAWINGS

As used herein, the term “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes”, or “including”, when used herein, specify the presence of stated features, integers, steps, operations, elements or components, but do not preclude the presence or addition of one or more other features, integers, steps, operations, elements, components or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

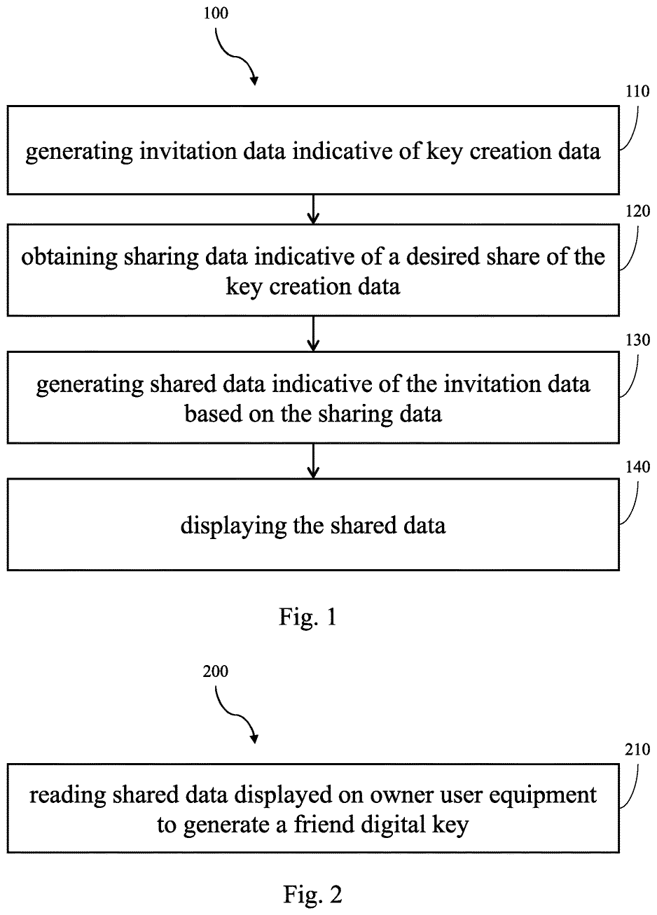

FIG. 1 shows an example of a method 100 for sharing a digital key. The method 100 may be performed by an owner user equipment (also referred to as owner device). The method 100 comprises generating 110 invitation data indicative of key creation data. The invitation data comprises relevant data for cross-platform sharing as described in [1].

Further, the method 100 comprises obtaining 120 sharing data indicative of a desired share the key creation data. The desired share may indicate if sharing of a digital key can be performed by transmitting a message and/or displaying information.

The method 100 further comprises generating 130 shared data indicative of the invitation data based on the sharing data. The shared data is to share with a friend device. Further, the method 100 comprises displaying 140 the shared data. By displaying 140 the shared data the friend device can receive, e.g., scan, information to assess the invitation data.

By obtaining the sharing data a desired step to share the invitation data can be determined. Thus, shared data can be generated based on the sharing data. By displaying the shared data for the user, e.g., a use of the friend device, can receive information indicative of the invitation data. In this way, the owner device can provide the friend device the invitation data in an improved way.

By displaying 140 the shared data a security of cross-platform sharing can be increased. A cross-platform sharing may be a sharing process without using user equipment original equipment manufacturer proprietary messaging mechanisms. In contrast, [1] discloses in chapter 11.3 communication channel that invitation data can only be sent over any messaging or chat channel. However, sending the invitation data by messaging app or a chat channel depends on the specific messaging app that is used in the sharing process and, specifically, might not prevent attacks such as a man-in-the-middle attack. Allowing the owner device to display the shared data only a friend device in a proximity of the owner device can receive the shared data. Thus, the man-in-the-middle attack can be prevented.

In an example, the method 100 may further comprise generating the key creation data and transmitting, to a server, the key creation data. Further, the shared data may be indicative of an address of the server, e.g., an URL-address, and URL-link. As described in [1] during cross-platform sharing the invitation data is transmitted to a (relay) server, e.g., a backend of a vehicle original equipment manufacturer. The shared data may comprise information about a storage place of the invitation data. Thus, by transmitting the invitation data to the (relay) server and displaying the shared data, the invitation data can be assessed by the friend device by reading the storage place and connecting to the (relay) sever.

In an example, the generated shared data is a QR code. Thus, the shared data can be displayed in a format which could be easily read by the friend device. In this way, releasing the shared data could be improved.

In an example, the method 100 may further comprise transmitting, to a vehicle (e.g., a communication device of the vehicle such as a central control unit), information about a usage of the shared data. The vehicle may be one to which the owner of the user equipment wishes to grant access to a friend. For example, the owner of the user equipment may transmit information about the usage of a QR Code to the vehicle. The information may be cryptographically secured. In this way, the vehicle can decide whether to entrust the digital key shared with the QR code without further proof.

In an example, the method 100 may further comprise prohibiting screenshot during displaying the shared data. Thus, it can be ensured that the shared data is not released in an undesired way. In this way, the shared data can only be read by a friend device in the proximity of the owner device.

In an example, the sharing data may be obtained by receiving from user equipment (friend device) the desired share, receiving from an input of the user of owner user equipment (owner device) the desired share and/or by determining the position of the user equipment. In this way, displaying the shared data can be initiated when needed. For example, the owner device may determine a position of the friend device. If the friend device is within a certain distance to the owner device, the owner device may initiate the displaying 140 of the shared data. Alternatively or optionally, the friend device may transmit a request for displaying the shared data to the owner device. Alternatively or optionally a user of the owner device may select the displaying 140 of the shared data. In this way, the owner can initiate the displaying 140 if needed.

For example, a user of the owner device may choose to perform a QR code based cross-platform proximity sharing of a digital key. Shared data comprising a QR-code, encoding the invitation URL of the server, can be generated by the owner device and displayed on a user interface. The user of the friend device can read/scan the QR code with the friend device. The friend device can identify the invitation URL as a digital key invitation and may connect to the server to receive the invitation data. In this way, the steps 4 and 5 as described above and defined in [1] can be replaced and/or extended to increase a security of sharing a digital key.

In general, the owner device may be a device that is capable of communicating wirelessly. In particular, however, the owner device may be a mobile user equipment, e.g., user equipment that is suitable for being carried around by a user. For example, the owner device may be a user terminal or user equipment within the meaning of the respective communication standards being used for mobile communication. For example, the owner device may be a mobile phone, such as a smartphone, or another type of mobile communication device, such as a smartwatch, a laptop computer, a tablet computer, or autonomous augmented-reality glasses.

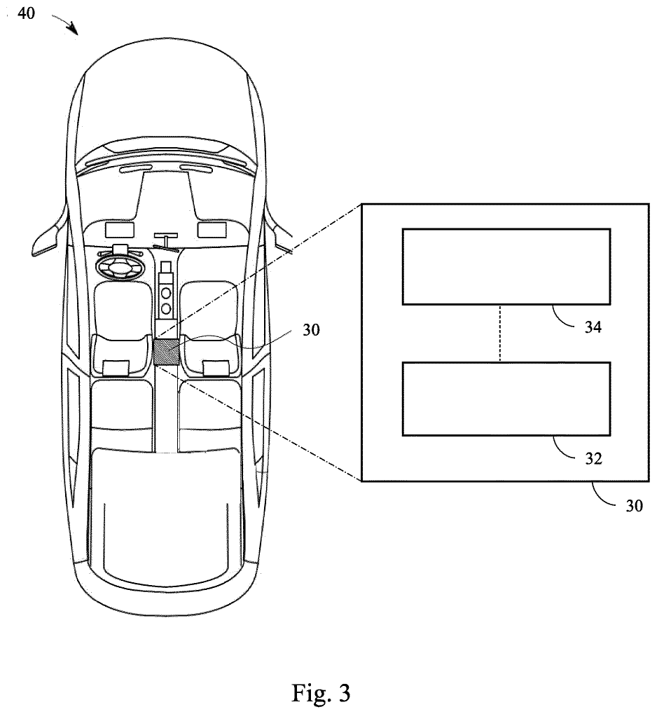

More details and aspects are mentioned in connection with the embodiments described below. The example shown in FIG. 1 may comprise one or more optional additional features corresponding to one or more aspects mentioned in connection with the proposed concept or one or more examples described below (e.g., FIGS. 2 and 3).

FIG. 2 another example of a method 200 for sharing a digital key. The method 200 may be performed by a friend device. The method 200 comprises reading shared data displayed on owner user equipment to generate a friend digital key. In this way, the friend device can receive the shared data indicative of the invitation data in an improved way. The method 200 may be performed by a friend device, which may be a counterpart to the owner device which performs the methods as described in FIG. 1.

In an example, the method may further comprise transmitting, to the owner user equipment, sharing data indicative of a desired share of key creation data. In this way, the friend device can transmit information about a desired share to the owner user equipment. For example, as described above the friend device may transmit a request to the owner device to trigger a displaying of the shared data. The request may comprise sharing data.

In general, the friend device may be a device that is capable of communicating wirelessly. In particular, however, the friend device may be a mobile user equipment, e.g., user equipment that is suitable for being carried around by a user. For example, the friend device may be a user terminal or user equipment within the meaning of the respective communication standards being used for mobile communication. For example, the friend device may be a mobile phone, such as a smartphone, or another type of mobile communication device, such as a smartwatch, a laptop computer, a tablet computer, or autonomous augmented-reality glasses.

More details and aspects are mentioned in connection with the embodiments described above and/or below. The example shown in FIG. 2 may comprise one or more optional additional features corresponding to one or more aspects mentioned in connection with the proposed concept or one or more examples described above (e.g., FIG. 1) and/or below (e.g., FIG. 3).

FIG. 3 shows a block diagram of an example of an apparatus 30 for a vehicle 40. The apparatus 30 comprises interface circuitry 32 configured to communicate with owner user equipment or friend user equipment and processing circuitry 34 configured to perform a method as described above, e.g., the method for owner user equipment as described with reference to FIG. 1 or the method for friend user equipment as described with reference to FIG. 2.

For example, the vehicle 40 may be a land vehicle, such a road vehicle, a car, an automobile, an off-road vehicle, a motor vehicle, a bus, a robo-taxi, a van, a truck or a lorry. Alternatively, the vehicle 40 may be any other type of vehicle, such as a train, a subway train, a boat or a ship. For example, the proposed concept may be applied to public transportation (trains, bus) and future means of mobility (e.g., robo-taxis).

As shown in FIG. 3 the respective interface circuitry 32 is coupled to the respective processing circuitry 34 at the apparatus 30. In examples the processing circuitry 34 may be implemented using one or more processing units, one or more processing devices, any means for processing, such as a processor, a computer or a programmable hardware component being operable with accordingly adapted software. Similar, the described functions of the processing circuitry 34 may as well be implemented in software, which is then executed on one or more programmable hardware components. Such hardware components may comprise a general-purpose processor, a Digital Signal Processor (DSP), a micro-controller, etc. The processing circuitry 34 is capable of controlling the interface circuitry 32, so that any data transfer that occurs over the interface circuitry 32 and/or any interaction in which the interface circuitry 32 may be involved may be controlled by the processing circuitry 34.

In an embodiment the apparatus 30 may comprise a memory and at least one processing circuitry 34 operably coupled to the memory and configured to perform the method described above.

In examples the interface circuitry 32 may correspond to any means for obtaining, receiving, transmitting or providing analog or digital signals or information, e.g., any connector, contact, pin, register, input port, output port, conductor, lane, etc, which allows providing or obtaining a signal or information. The interface circuitry 32 may be wireless or wireline and it may be configured to communicate, e.g., transmit or receive signals, information with further internal or external components.

The apparatus 30 may be a computer, processor, control unit, (field) programmable logic array ((F)PLA), (field) programmable gate array ((F)PGA), graphics processor unit (GPU), application-specific integrated circuit (ASICs), integrated circuits (IC) or system-on-a-chip (SoCs) system.

More details and aspects are mentioned in connection with the embodiments described. The example shown in FIG. 3 may comprise one or more optional additional features corresponding to one or more aspects mentioned in connection with the proposed concept or one or more examples described above (e.g., FIG. 1 and FIG. 2).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

If some aspects have been described in relation to a device or system, these aspects should also be understood as a description of the corresponding method and vice versa. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

The aspects and features described in relation to a particular one of the previous examples may also be combined with one or more of the further examples to replace an identical or similar feature of that further example or to additionally introduce the features into the further example.

References

| | |
|---|---|
| 30 | apparatus |
| 32 | processing circuitry |
| 34 | interface circuitry |
| 40 | vehicle |
| 100 | method for improving sharing a digital key |
| 110 | generating invitation data |
| 120 | obtaining sharing data |
| 130 | generating shared data |
| 140 | displaying the shared data |
| 200 | method for improving sharing a digital key |
| 210 | reading shared data |

1.-10. (canceled)

11. A method for improving sharing a digital key, the method comprising:
generating invitation data indicative of key creation data;
obtaining sharing data indicative of a desired share of the key creation data;
generating shared data indicative of the invitation data based on the sharing data; and
displaying the shared data.

12. The method according to claim 11, further comprising:
generating the key creation data; and
transmitting, to a server, the key creation data;
wherein the shared data is indicative of an address of the server.

13. The method according to claim 11, wherein the shared data is a QR code.

14. The method according to claim 12, wherein the shared data is a QR code.

15. The method according to claim 11, further comprising:
transmitting, to a vehicle, information about a usage of the shared data.

16. The method according to claim 12, further comprising:
transmitting, to a vehicle, information about a usage of the shared data.

17. The method according to claim 13, further comprising:
transmitting, to a vehicle, information about a usage of the shared data.

18. The method according to claim 11, wherein the sharing data is obtained by at least one of receiving from user equipment the desired share, receiving from an input of a user of the user equipment the desired share or by determining a position of the user equipment.

19. The method according to claim 12, wherein the sharing data is obtained by at least one of receiving from user equipment the desired share, receiving from an input of a user of the user equipment the desired share or by determining a position of the user equipment.

20. The method according to claim 13, wherein the sharing data is obtained by at least one of receiving from user equipment the desired share, receiving from an input of a user of the user equipment the desired share or by determining a position of the user equipment.

21. A method for improving sharing of a digital key, the method comprising:
reading shared data displayed on owner user equipment to generate a friend digital key.

22. The method according to claim 21, further comprising:
transmitting, to the owner user equipment, sharing data indicative of a desired share of key creation data.

23. An apparatus comprising:
interface circuitry configured to communicate with at least one of a communication device, a user equipment, and a backend; and
processing circuitry configured to
generate invitation data indicative of key creation data;
obtain sharing data indicative of a desired share of the key creation data;
generate shared data indicative of the invitation data based on the sharing data; and
display the shared data.

24. The apparatus according to claim 23, wherein the processing circuitry is further configured to:
generate the key creation data; and
transmit the key creation data to a server;
wherein the shared data is indicative of an address of the server.

25. The apparatus according to claim 23, wherein the shared data is a QR code.

26. The apparatus according to claim 23, wherein the processing circuitry is further configured to transmit, to a vehicle, information about a usage of the shared data.

27. The apparatus according to claim 23, wherein the sharing data is obtained by at least one of receiving from user equipment the desired share, receiving from an input of a user of the user equipment the desired share or by determining a position of the user equipment.

28. A vehicle comprising an apparatus according to claim 23.

29. A non-transitory computer-readable medium storing a program having a program code for execution on a computer, a processor, or a programmable hardware component that performs a method according to claim 11.
